(19) United States
(12) Patent Application Publication
(10) Pub. No.: US 2015/0093734 A1
(43) Pub. Date: Apr. 2, 2015

(54) SURGICAL ASSISTANCE USING PHYSICAL MODEL OF PATIENT TISSUE

(71) Applicant: THE CLEVELAND CLINIC FOUNDATION, Cleveland, OH (US)

(72) Inventor: Jihad Kaouk, Cleveland, OH (US)

(21) Appl. No.: 14/495,975

(22) Filed: Sep. 25, 2014

Related U.S. Application Data
(60) Provisional application No. 61/883,300, filed on Sep. 27, 2013.
(60) Provisional application No. 61/931,732, filed on Jan. 27, 2014.

(51) Int. Cl. G09B 23/30

(52) U.S. Cl. CPC G09B 23/30
USPC 434/267

(57) ABSTRACT

A method for assisting with a surgical procedure upon a native patient tissue using a physical model of the native patient tissue includes providing a three-dimensional physical model of a patient tissue. At least one surgical action is performed upon the physical model. The at least one surgical action performed upon the physical model is recorded. A planned surgical itinerary including the at least one recorded action performed upon the physical model is produced. The surgical actions of the planned surgical itinerary are performed upon at least one of the native patient tissue and a three-dimensional physical model of a patient tissue. Adherence of the performed surgical actions to the planned surgical itinerary is monitored.

### RELATED APPLICATION

This application claims priority from U.S. Provisional Application No. 61/883,300, filed 27 Sep. 2013 and from U.S. Provisional Application No. 61/931,732, filed 27 Jan. 2014, the subject matter of both of which is incorporated herein by reference in its entirety.

### TECHNICAL FIELD

The present invention relates to a method for assisting with a surgical procedure and, more specifically, to a method for planning and/or rehearsing a surgical procedure upon a native patient tissue using a physical model of the native patient tissue.

### BACKGROUND

In the medical field, it may be desirable for a surgeon or other medical user (such as, but not limited to, a physician's assistant, medical trainee, nurse, or other user, hereafter collectively referenced as a “user”) to be able to manipulate at least one artificially-produced physical model or copy of a native patient tissue, for training, preparation for surgery, or any other purpose. For example, a user may desire to realistically rehearse a particular surgical procedure in general, but there is no readily available cadaver tissue exhibiting the desired structure or pathology. As another example, an experienced user may wish to physically test and compare different, potentially mutually exclusive, possible surgical approaches when performing surgical planning for a particular patient situation, and therefore would need to have several “copies” of the native patient tissue available. A third example involves the provision of multiple “copies” of a single, specific pathological patient tissue (generically generated and/or chosen from a library of actual patient tissues) so that an instructor and one or more students can concurrently encounter virtually identical configurations for ease of instruction and/or comparison.

It is currently known to provide generic physical models, such as “Sawbones” physical patient tissue models (available from Pacific Research Laboratories, Inc. of Vashon, Wash.) or three-dimensionally (“3D”) printed copies of specific patient tissues, in the medical field to allow for rehearsals/planning, training, or other physical modifications of a structure that substantially replicates a generic or specific patient tissue. Indeed, it has recently become possible to 3D-print patient tissue models, using rapid prototyping and/or additive manufacturing processes, that substantially replicate even the various densities and internal structures of a patient soft tissue, such as an organ. Using modern physical models of (generic or specific) native patient tissues, a surgical procedure, including one or more surgical actions or tasks, may be performed as many times as desired before, optionally, the surgical procedure is actually performed on the patient's own native tissue corresponding to the physical models used in rehearsal/planning. However, difficulties may arise when a surgeon or other user wishes to transfer specific surgical actions or tasks precisely to the native patient tissue.

### SUMMARY

A method for assisting with a surgical procedure upon a native patient tissue using a physical model of the native patient tissue is provided. A three-dimensional physical model of a patient tissue is provided. At least one surgical action is performed upon the physical model. The at least one surgical action performed upon the physical model is recorded. A planned surgical itinerary including the at least one recorded action performed upon the physical model is produced. The surgical actions of the planned surgical itinerary are performed upon at least one of the native patient tissue and a three-dimensional physical model of a patient tissue. Adherence of the performed surgical actions to the planned surgical itinerary is monitored.

A method for rehearsing a surgical procedure upon a native patient tissue using a physical model of the native patient tissue is provided. A first three-dimensional physical model of a patient tissue is provided. At least one surgical action is performed upon the first physical model. The at least one surgical action performed upon the first physical model is recorded. A planned surgical itinerary including the at least one recorded action performed upon the first physical model is produced. The surgical actions of the planned surgical itinerary are performed upon a second three-dimensional physical model of a patient tissue. Adherence of the performed surgical actions to the planned surgical itinerary is monitored. Adherence of the performed surgical actions to the planned surgical itinerary is communicated to a user in a user-perceptible form.

### BRIEF DESCRIPTION OF THE DRAWINGS

For a better understanding, reference may be made to the accompanying drawings, in which:

FIG. 1 is a flowchart showing an aspect of the present invention; and

FIG. 2 is a flowchart showing another aspect of the present invention.

### DESCRIPTION

The invention comprises, consists of, or consists essentially of the following features, in any combination.

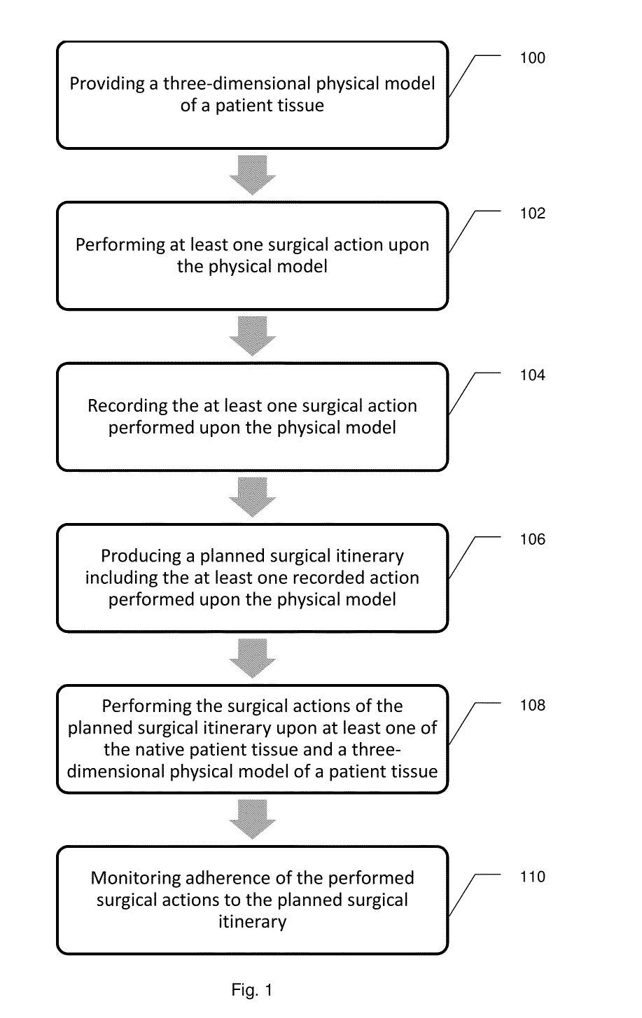

FIG. 1 depicts a method for assisting with a surgical procedure upon a native patient tissue using a physical model of the native patient tissue. As used herein, a “surgical procedure” includes one or more “surgical actions”, examples of which include discrete physical manipulations and/or changes to the native patient tissue undergoing the surgical procedure. A “physical model” is used herein to indicate a three-dimensional, palpable, tangible, material structure (as opposed to a “virtual model”, which exists only in a computer or other data-representation space) which substantially replicates a specific and/or generic patient tissue. For example, a native patient tissue (e.g., a tissue found in the patient's body in a congenital and/or acquired condition) could be imaged two- and/or three-dimensionally and optionally virtually manipulated and/or altered, such as with the assistance of computer tools. The resultant “final” images of the native patient tissue could then be transformed into a physical model—made of any suitable material(s)—using any suitable manufacturing process such as, but not limited to, rapid prototyping and/or additive manufacturing processes, lost wax casting, and molding.

The virtual model of the native patient tissue may be based upon, for example, scanned image data taken from an imaging scan of the native patient tissue. The term “model” is used herein to indicate a replica or copy of a physical item, at any relative scale and represented in any medium, physical or virtual. The virtual and physical models may be total or partial model of a subject patient tissue, and may be created in any suitable manner. For example, and as presumed in the below description, the virtual model may be based upon computer tomography (“CT”) data imported into a computer aided drafting (“CAD”) system. Additionally or alternatively, the virtual model may be based upon digital or analog radiography, magnetic resonance imaging, or any other suitable imaging means. The virtual model will generally be displayed for the user to review and manipulate preoperatively, such as through the use of a computer or other graphical workstation interface. The physical model may be made from any suitable material (e.g., metals, plastics, colloids, other materials, or any combinations thereof) and by any suitable method such as, but not limited to, selective laser sintering (“SLS”), fused deposition modeling (“FDM”), stereolithography (“SLA”), laminated object manufacturing (“LOM”), electron beam melting (“EBM”), 3-dimensional printing (“3DP”), contour milling from a suitable material, computer numeric control (“CNC”), other rapid prototyping methods, or any other desired manufacturing process.

FIG. 1 depicts one example of a method for assisting with a surgical procedure upon a native patient tissue using a physical model of the native patient tissue, regardless of how the physical model is obtained. In the method described in FIG. 1, the physical model is a three-dimensional construct which substantially replicates a particular native patient tissue that is to be the subject of a surgical procedure rehearsed with the method. However, it is also contemplated that the physical model could also or instead be a generic patient tissue, e.g., one selected from a library of patient tissues and/or generated as an amalgam of multiple patient tissues, optionally edited or configured to include one or more features not present in the source patient tissue(s). In this manner, the physical model can be either used to assist with a surgical procedure involving a condition/pathology/configuration found in a particular, patient-specific native patient tissue, or to assist with a surgical procedure involving a condition/pathology/configuration which is relatively generic to that type of patient-specific native patient tissue (as opposed to being a substantial replica of that patient's condition).

For example, a patient-specific kidney could be substantially replicated in physical model form, to allow a user to rehearse one or more surgical approaches for that particular patient (e.g., to excise a particular tumor) or otherwise become familiar with the patient's specific anatomy for any reason. As another example, a kidney having a known type/class of pathology or structure could be chosen from a library to expose a trainee user to that particular kidney configuration without reference to the native tissue of a specific patient.

In block 100 of the method shown in FIG. 1, a three-dimensional physical model of a patient tissue is provided. As discussed elsewhere herein, that physical model may be provided in any suitable way, and may arise from any suitable source. For the example method of FIG. 1, it will be presumed that the physical model bears some resemblance to a native patient tissue which is to be the subject of a surgical procedure.

In block 102 of the example method of FIG. 1, at least one surgical action is performed upon the physical model. As previously mentioned, surgical actions are referenced herein as being discrete physical manipulations and/or changes to the native patient tissue undergoing the surgical procedure such as, but not limited to, cuts, tears, sutures, adhesions, cauterizations, retractions, compressions, and/or any other physical manipulations and/or changes, whether produced manually and/or automatically, using any suitable tools (e.g., scalpels, forceps, Bovie knives, electrodes, surgical robots, fingers) or combinations thereof. For example, and as will be further discussed, at least one surgical action can be performed upon the physical model using a surgical robot, which itself can be preprogrammed and/or substantially real-time-controlled by a user.

Optionally, part or all of a simulated surgical procedure, including a plurality of surgical actions, can be performed upon the physical model. For example, a simulated tumor removal could be performed on a physical model of a kidney having a tumor, including the surgical actions of cutting into the kidney, resecting and removing the tumor, and closing the surgical wound. As another option, a plurality of simulated surgical procedures, each including a plurality of surgical actions, could be performed upon the physical model. As a follow-on to the above example, a plurality of simulated tumor removals, each simulation being performed by the same user or one or more different users, could be performed either repeatedly upon the same physical model or upon a plurality of different physical models.

Stated differently, and particularly when a plurality of substantially similar three-dimensional physical models of a patient tissue are provided, a plurality of users could each perform a simulated surgical procedure, each including a plurality of surgical actions, upon a chosen one of the plurality of physical models. In this manner, each user making up a class of medical trainees could be confronted with the same surgical conundrum, embodied in one of the substantially similar physical models, and an instructor could then independently review and compare the surgical technique and proficiency of each trainee without having to account for physical differences between the users' cadavers or other nonhomogenous surgical subjects.

The example method of FIG. 1 moves from the performance of surgical actions in block 102 to block 104, wherein at least one of the surgical actions performed upon the physical model is recorded, in any suitable manner. For example, if the at least one surgical action is performed upon the physical model using a surgical robot, the robot controller can record the movement commands sent to the robot by the user. When a surgical robot is used, at least one landmark (of any suitable tangible or intangible type) may be associated with the physical model; the landmark, when present, may be provided to assist with orientation for the surgical robot.

The example method of FIG. 1, or any other method of use of the present invention, could also or instead be used to record information related to the use of a surgical robot in any desired way, recording items such as, but not limited to, the actions taken by the robot in response to at least one automated command, the actions taken by the robot in response to at least one manual command, the commands sent from one portion of the robot system to another, the positions of one or more portions of the robot system, or any other recordable factor related to robot use. Recorded information related to a surgical robot's interaction with the physical model may be used at a later time for an at least partially semiautomatic and/or fully autonomous robotic surgical procedure upon a native patient tissue.

As another example, the user could be recorded visually by a motion capture system, possibly with the assistance of one or more reflective dots or other aids highlighting the positions and/or motions of the user and/or tools. As a further example, a pantograph linkage or other physical tool or measurement system could be used to capture the positions and/or motions of the user and/or tools during the performance of one or more surgical actions.

Regardless of how the recordation is performed in block 104, the example method then moves to block 106, wherein a planned surgical itinerary including the at least one recorded action performed upon the physical model is produced. As an example, the surgical itinerary could include surgical actions (taken from any desired source, including a library of user-created and/or previously performed/recorded surgical actions) which were not recorded in block 104 combined with one or more surgical actions which were recorded in block 104.

The planned surgical itinerary could also or instead include recorded actions from multiple ones of the plurality of surgical procedures, selected manually or automatically for inclusion in the planned surgical itinerary according to any desired selection criteria. For example, and using the aforementioned kidney tumor removal simulated surgical procedure as a use environment, the planned surgical itinerary could use an opening incision from a first iteration of the simulated surgical procedure, the tumor resection from a second iteration, the tumor removal from the first iteration again, and the wound closure from a third iteration. The various iterations can be performed by the same or different users. In this manner, the planned surgical itinerary could be a composite of “best practice” surgical actions intended to provide a desired surgical outcome. Optionally, a specific series of surgical actions could be morphed together automatically and/or manually (e.g., with the assistance of a surgical robot controller), for example, to overcome positional disparities between the end tool positions of one surgical action and the beginning tool positions of a subsequent surgical action, and/or to “fill in” a desired surgical action for which there is no previously recorded analogue.

In block 108 of the example method of FIG. 1, the surgical actions of the planned surgical itinerary are performed upon at least one of the native patient tissue and a three-dimensional physical model of a patient tissue. That is, whether the surgical actions are performed manually and/or automatically (e.g., robotically), by any user, with any tools, the surgical itinerary is carried out. The subject of the surgical actions in block 108 can be a same physical model which was the subject of earlier surgical actions, a different physical model, and/or the native patient tissue upon which the physical model is based. That is, the surgical actions of the planned surgical itinerary may be performed upon the native patient tissue, such as, for example, if the surgical itinerary was planned using at least one “rehearsal” surgical action performed on a physical model. The surgical actions may be performed in any desired manner, such as, but not limited to, manually, automatically, robotically, or any combination thereof.

The surgical actions of the planned surgical itinerary may also or instead be performed upon at least one physical model (whether or not the physical model was previously the subject of at least one surgical action, such as, for example, to validate the planned surgical itinerary and/or test the skills of a user in carrying out the planned surgical itinerary. E.g., when the physical model is a first physical model, a second physical model can be provided, and the surgical actions of the planned surgical itinerary can be performed upon the second physical model.

Once at least one surgical action has been commenced in block 108, adherence of the performed surgical actions to the planned surgical itinerary is monitored in block 110 of the example method of FIG. 1. This may be accomplished at least partially through the use of a system or method used in the recording of block 104. For example, when at least a portion of the surgical actions are performed manually and/or automatically (e.g., robotically), the position of at least a portion of a tool and/or a user may be detected and compared (optionally in real- or near-real-time) to a planned/expected position of a corresponding portion of a tool and/or a user at that planned surgical action of the planned surgical itinerary. As another example, a result of a performed surgical action (e.g., the length and/or orientation of a scalpel incision) could be detected and compared to a planned/expected result of a planned surgical action.

The adherence monitoring of block 110 could be performed at any time, including post-surgically, but will preferably be performed, for most use applications of the present invention, while the planned surgical itinerary is still being carried out. If adherence monitoring is performed intraoperatively, the planned surgical itinerary could be adjusted intraoperatively (optionally in real- or near-real-time) to compensate for any difference(s) detected by the intraoperative monitoring while still striving toward an ultimate goal of the planned surgical itinerary. That is, at least one surgical action of the planned surgical itinerary could be intraoperatively adjusted, responsive to the monitored adherence of the performed surgical actions to the planned surgical itinerary, to improve adherence of the performed surgical actions to the planned surgical itinerary. Particularly when a surgical robot is involved in at least partially performing at least one surgical action during block 108, such intraoperative adjustment could be performed by a controller of the surgical robot.

Whether or not the adherence monitoring of block 110 contributes to some intraoperative adjustment, the monitored adherence of the performed surgical actions to the planned surgical itinerary could be communicated to a user in a user-perceptible form. For example, a warning light, sound (e.g., buzzer), tactile response (e.g., vibration), numerical scale, graphical representation (e.g., table, graph, phantom/outline overlay), or any other suitable user-perceptible indication could be provided to the user, optionally in real- or near-real-time, in any format, at any time (including intraoperatively and postoperatively), and for any reason. E.g., the user could be notified when a tool strays out of a permissible zone during a procedure so that the tool can be repositioned within the permissible zone; an “instant replay” or video recap of at least one surgical action could be played for a user (the same user that performed at least a portion of the planned surgical itinerary and/or a different user) during or after the surgery; a count could be kept of the number of times a tool (including a user's hand/arm/finger) exhibits a detected out-of-position status (such as to help a user refine/rehearse a surgical technique); or any other monitored property could be communicated to any user(s), in any suitable way, and for any reason.

Once the steps of the example method of FIG. 1 have been carried out, any other methods, steps, or other actions can be performed—e.g., the surgical results can be reviewed. If the planned surgical itinerary of block 108 of FIG. 1 has been performed upon a physical model and adherence monitored in block 110 (and optionally communicated to a user), for example, the planned surgical itinerary could then be adjusted as desired and performed, in a repeat of block 108, upon the native patient tissue. In any event, any of the steps or actions shown in FIG. 1 and described above could be combined, in any suitable order, to achieve a desired surgical, training, rehearsal, or other result.

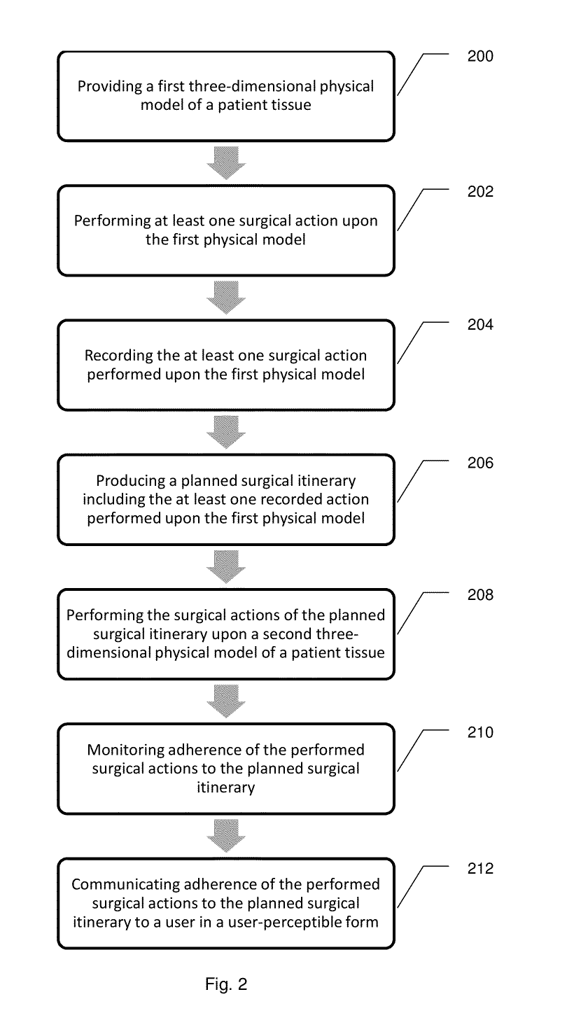

Turning to FIG. 2, an example use environment of the example method of FIG. 1 is more specifically shown. In FIG. 2, the example method shown is for rehearsing a surgical procedure upon a native patient tissue using a physical model of the native patient tissue. The example method of FIG. 1 includes aspects and features that have similarities to aspects and features of the example method of FIG. 2. For brevity, the above description concerning such similar aspects and features of the example method of FIG. 1 will not be repeated below, but should be presumed to apply as appropriate to the below-described example method of FIG. 2.

In block 200 of the example method of FIG. 2, a first three-dimensional physical model of a patient tissue is provided. In block 202, at least one surgical action is performed upon the first physical model. For example, a simulated surgical procedure, including a plurality of surgical actions, may be performed upon the first physical model—e.g., a tumor could be resected and removed from a first physical model of a particular native patient tissue as rehearsal for an actual tumor resection and removal from the patient. As discussed above with reference to FIG. 1, the at least one surgical action may be performed, for example, with a surgical robot. Optionally, at least one landmark (not shown), such as a tactile, visible, or other appropriately-perceptible feature, may be associated with the first physical model for any desired reason, including to assist with orientation for the surgical robot.

In block 204 of the example method of FIG. 2, the at least one surgical action performed upon the first physical model is recorded. The example method then proceeds to block 206, wherein a planned surgical itinerary is produced. The planned surgical itinerary may include the at least one recorded surgical action performed upon the first physical model, optionally in combination with one or more surgical actions that are taken from a library of available surgical actions, created in a custom manner by a user and/or automatic routine, recorded in another instance of a surgical action being performed on a physical model, or from any other source.

Optionally, a plurality of simulated surgical procedures, each including a plurality of surgical actions, could be performed upon the first physical model. Any number of the surgical actions, from any of the simulated surgical procedures, could be recorded. The plurality of simulated surgical procedures need not have the same surgical goal or intent—for example, a physical model of a heart could be reused to separately rehearse both a stent placement and a valve resection, in much the same way that a practice hair mannequin is used in cosmetology school to allow a student to successively learn/rehearse longer, then shorter haircuts. Alternatively, the plurality of simulated surgical procedures could be performed successively or simultaneously upon the first physical model to test or compare various surgical approaches to the same surgical problem—e.g., a tumor could be resected leaving various margins or borders so that a user can consider how to avoid or mitigate damage to adjacent healthy tissue.

The planned surgical itinerary could include at least one recorded action from multiple ones of the plurality of the simulated surgical procedures. In this manner, a “best practices” planned surgical itinerary could be created, if desired, by picking and choosing various surgical actions from across several simulated surgical procedures.

In block 208 of the example method of FIG. 2, the surgical actions of the planned surgical itinerary are performed upon a second physical model. The second physical model is provided to allow the user to experience the planned surgical itinerary as performed on a “virgin”, unaltered physical model. Optionally, the user performing the planned surgical itinerary of block 208 could be different from the user performing the surgical action(s) of block 202—for example, if a trainee surgeon is trying to replicate one or more surgical actions as performed by a more experienced surgeon. As with all of the surgical actions described herein, any one or more of the surgical actions of the planned surgical itinerary of block 208 could be performed, automatically or manually controlled, with the assistance of a surgical robot.

In block 210 of the example method of FIG. 2, adherence of the performed surgical actions to the planned surgical itinerary is monitored, in any desired manner. The monitored adherence is then communicated to a user (who could be any user, whether or not previously connected with any of the earlier steps of the example method) in any suitable user-perceptible form in block 212. The combination of the steps of blocks 210 and 212 can help, for example, monitoring and evaluation of a trainee surgeon's performance by a supervisor, perhaps leading to feedback provided to the trainee surgeon for improving surgical performance in the future.

Optionally, the monitored adherence could be communicated to the user or otherwise used (e.g., by being provided to a surgical robot controller) to help manually and/or automatically intraoperatively adjust at least one surgical action, responsive to the monitored adherence, to improve adherence of the performed surgical actions to the planned surgical itinerary. For example, if the performance of the planned surgical itinerary of block 208 is being carried out by a trainee surgeon who accumulates significant errors in the surgical actions resulting in presence of surgical tools far afield from the expected/planned positions, intraoperative adjustments could be provided to allow the trainee surgeon to “reset” the tools back into the expected/planned positions, so that later-performed surgical actions start from the expected configuration instead of an out-of-position configuration imposed by earlier errors or surgical decisions/actions.

As with all aspects of the present invention, the example method of FIG. 2 could be performed for any reason, and using a physical model(s) that are based upon any native patient tissue and/or fabricated anatomical configuration which is not necessarily taken from a particular native patient tissue.

Particularly when a simulated surgical procedure materially alters the first physical model to such an extent that a later simulated surgical procedure on the same physical model would encounter an inaccurate rendition of the native patient tissue (i.e., the same physical model has been changed to no longer substantially simulate the native patient tissue), it is contemplated that one or more of the plurality of simulated surgical procedures could be performed on additional, separately provided physical models. The described example surgical methods, in certain use environments, are agnostic as to which of a plurality of physical models is subject to one or more surgical actions and/or recordations in the preparation and execution of a planned surgical itinerary.

While aspects of the present invention have been particularly shown and described with reference to the preferred aspect above, it will be understood by those of ordinary skill in the art that various additional aspects may be contemplated without departing from the spirit and scope of the present invention. For example, the specific methods described above for using the described system are merely illustrative; one of ordinary skill in the art could readily determine any number of tools, sequences of steps, or other means/options for virtually or actually placing the above-described apparatus, or components thereof, into positions substantially similar to those shown and described herein. Any of the described structures and components could be integrally formed as a single piece or made up of separate sub-components, with either of these formations involving any suitable stock or bespoke components and/or any suitable material or combinations of materials. For any desired reason (including, but not limited to, cost savings or model availability), the planned surgical itinerary of block 208 could instead be performed upon the first physical model. One or more of the steps of the example methods of FIGS. 1 and 2 could be carried out entirely via automatic means, with substantially no user control during performance of the step(s). Though certain components described herein are shown as having specific geometric shapes, all structures of the present invention may have any suitable shapes, sizes, configurations, relative relationships, cross-sectional areas, or any other physical characteristics as desirable for a particular application of the present invention. Any structures or features described with reference to one aspect or configuration of the present invention could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of the present invention as determined based upon the claims below and any equivalents thereof.

Other aspects, objects, and advantages of the present invention can be obtained from a study of the drawings, the disclosure, and the appended claims.

Having described the invention, I claim:

1. A method for assisting with a surgical procedure upon a native patient tissue using a physical model of the native patient tissue, the method comprising the steps of:
providing a three-dimensional physical model of a patient tissue;
performing at least one surgical action upon the physical model;
recording the at least one surgical action performed upon the physical model;
producing a planned surgical itinerary including the at least one recorded action performed upon the physical model;
performing the surgical actions of the planned surgical itinerary upon at least one of the native patient tissue and a three-dimensional physical model of a patient tissue; and
monitoring adherence of the performed surgical actions to the planned surgical itinerary.

2. The method of claim 1, wherein the step of performing at least one surgical action upon the physical model includes the step of performing at least one surgical action upon the physical model using a surgical robot.

3. The method of claim 2, including the step of associating at least one landmark with the physical model, the landmark being provided to assist with orientation for the surgical robot.

4. The method of claim 1, wherein the step of performing at least one surgical action upon the physical model includes the step of:
performing a simulated surgical procedure, including a plurality of surgical actions, upon the physical model.

5. The method of claim 4, including the step of performing a plurality of simulated surgical procedures, each including a plurality of surgical actions, upon the physical model.

6. The method of claim 1, wherein the step of providing a three-dimensional physical model of a patient tissue includes the step of providing a plurality of substantially similar three-dimensional physical models of the patient tissue, and including the step of performing a plurality of simulated surgical procedures, each including a plurality of surgical actions, each being performed upon a chosen one of the plurality of substantially similar three-dimensional physical models of the patient tissue.

7. The method of claim 5, wherein the step of producing a planned surgical itinerary including the at least one recorded action performed upon the physical model includes the step of selecting at least one recorded action from multiple ones of the plurality of the simulated surgical procedures to include in the planned surgical itinerary.

8. The method of claim 1, including the step of communicating adherence of the performed surgical actions to the planned surgical itinerary to a user in a user-perceptible form.

9. The method of claim 1, wherein the step of performing the surgical actions of the planned surgical itinerary includes the step of intraoperatively adjusting at least one surgical action, responsive to the monitored adherence of the performed surgical actions to the planned surgical itinerary, to improve adherence of the performed surgical actions to the planned surgical itinerary.

10. The method of claim 9, wherein the step of intraoperatively adjusting at least one surgical action is performed by a controller of a surgical robot.

11. The method of claim 1, wherein the three-dimensional physical model of a patient tissue is a first three-dimensional physical model of a patient tissue, and wherein the step of performing the surgical actions of the planned surgical itinerary upon at least one of the native patient tissue and a three-dimensional physical model of a patient tissue includes the steps of:
providing a second three-dimensional physical model of the patient tissue; and
performing the surgical actions of the planned surgical itinerary upon the second three-dimensional physical model of the patient tissue.

12. The method of claim 1, wherein the step of providing a three-dimensional physical model of a patient tissue includes the step of providing a three-dimensional physical model of a patient tissue which substantially replicates a particular patient tissue that is to be the subject of a surgical procedure rehearsed with the method.

13. The method of claim 1, wherein the step of providing a three-dimensional physical model of a patient tissue includes the step of providing a three-dimensional physical model of a patient tissue which is a generic patient tissue selected from a library of patient tissues.

14. A method for rehearsing a surgical procedure upon a native patient tissue using a physical model of the native patient tissue, the method comprising the steps of:
providing a first three-dimensional physical model of a patient tissue;
performing at least one surgical action upon the first physical model;
recording the at least one surgical action performed upon the first physical model;
producing a planned surgical itinerary including the at least one recorded action performed upon the first physical model;
performing the surgical actions of the planned surgical itinerary upon a second three-dimensional physical model of a patient tissue;
monitoring adherence of the performed surgical actions to the planned surgical itinerary; and
communicating adherence of the performed surgical actions to the planned surgical itinerary to a user in a user-perceptible form.

15. The method of claim 14, wherein the step of performing at least one surgical action upon the first physical model includes the step of performing at least one surgical action upon the first physical model using a surgical robot.

16. The method of claim 14, wherein the step of performing the surgical actions of the planned surgical itinerary upon a second three-dimensional physical model of a patient tissue includes the step of performing the surgical actions of the planned surgical itinerary upon the second physical model using a surgical robot.

17. The method of claim 15, including the step of associating at least one landmark with at least one of the first physical model and the second physical model, the landmark being provided to assist with orientation for the surgical robot.

18. The method of claim 14, wherein the step of performing at least one surgical action upon the first physical model includes the step of:
performing a simulated surgical procedure, including a plurality of surgical actions, upon the first physical model.

19. The method of claim 18, including the step of performing a plurality of simulated surgical procedures, each including a plurality of surgical actions, upon the first physical model.

20. The method of claim 14, wherein the step of providing a first three-dimensional physical model of a patient tissue includes the step of providing a plurality of substantially similar three-dimensional physical models of the patient tissue, and including the step of performing a plurality of simulated surgical procedures, each including a plurality of surgical actions, each being performed upon a chosen one of the plurality of substantially similar three-dimensional physical models of the patient tissue.

21. The method of claim 19, wherein the step of producing a planned surgical itinerary including the at least one recorded action performed upon the first physical model includes the step of selecting at least one recorded action from multiple ones of the plurality of the simulated surgical procedures to include in the planned surgical itinerary.

22. The method of claim 14, wherein the step of performing the surgical actions of the planned surgical itinerary includes the step of intraoperatively adjusting at least one surgical action, responsive to the monitored adherence of the performed surgical actions to the planned surgical itinerary, to improve adherence of the performed surgical actions to the planned surgical itinerary.

23. The method of claim 22, wherein the step of intraoperatively adjusting at least one surgical action is performed by a controller of a surgical robot.

24. The method of claim 14, wherein the step of providing a first three-dimensional physical model of a patient tissue includes the step of providing a first three-dimensional physical model of a patient tissue which is at least one of (1) substantially similar to a particular patient tissue that is to be the subject of a surgical procedure rehearsed with the method and (2) a generic patient tissue selected from a library of patient tissues.
